(19) United States
(12) Patent Application Publication
(10) Pub. No.: US 2007/0115116 A1
(43) Pub. Date: May 24, 2007

(54) System and method for wireless communication of facility data

(75) Inventor: Bernard Baran Zabek, Clifton Park, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/282,705

(22) Filed: Nov. 21, 2005

(51) Int. Cl. G08B 1/08; G08C 19/16

(52) U.S. Cl. 340/539.22; 340/870.01

(57) ABSTRACT

A novel wireless data communication topology collecting and transmitting data from various sensors and other data sources in a facility. The topology includes serial data modems, serial to Ethernet converters, Ethernet to General Purpose Interface Bus (GPIB) converters, wireless data transmitters and wireless Ethernet radios, e.g., wireless bridges. These data transmission devices transmit data collected from sensors, test instruments and other data generators that monitor a facility. The transmitted data is uploaded to data collection computer systems that may be networked using a LAN (local area network) an intranet and/or internet.

### BACKGROUND OF THE INVENTION

The invention relates to wireless data communication for a wide area industrial facility and, in particularly, to a data communication topology for a facility having multiple modes of wireless communication and different types of data sources.

Facilities, such as power generation plants, manufacturing plants and other industrial facilities, generate large amounts of data regarding their operation. Data may be generated by sensors that monitor the operation of the various components of the facility. A power generation plant, for example, may include combined cycle gas and steam turbines, heat recovery steam generators, electrical power generator, exhaust emission control devices, cooling towers, yards for transmission lines, spare parts and maintenance equipment, control offices and other sub-systems. These devices and sub-systems may be distributed at various locations within a large facility and at locations remote from the facility. The devices and sub-systems in a facility may be outfitted with sensors and other data generators. The data from all of the sensors are transmitted to one or more computer systems.

Wire connections are conventionally used to established data transmission from sensors to data collection computers for facilities. Wire connections are often expensive and difficult to install, especially if the wiring is required to pass through walls and buildings, and extend long distances, e.g., across roadways. Further, wiring does not easily accommodate changes to sensor placement and the layout of devices and sub-systems in a facility. There is a long felt need for data transmission systems that overcome some of the difficulties and are less expensive than wiring.

### BRIEF DESCRIPTION OF THE INVENTION

A novel wireless data communication topology has been developed for collecting and transmitting data from various sensors and other data sources in a facility. The topology includes serial data modems, serial to Ethernet converters, Ethernet to General Purpose Interface Bus (GPIB) converters, wireless data transmitters and wireless Ethernet radios, e.g., wireless bridges. These data transmission devices transmit data collected from sensors, test instruments and other data generators that monitor a facility. The transmitted data is uploaded to data collection computer systems that may be networked using a LAN (local area network) an intranet and/or internet.

A data communications topology for a facility has been developed comprising: a wireless mesh network of a first type of sensors monitoring the facility; a wireless data communication device coupled to the wireless mesh network and serving as an addressable node on a local area network (LAN); a plurality of repeating data transceiving radios each coupled to a second type of sensors monitoring the facility wherein at least one of the radios is an addressable link on the LAN.

The facility may include a combined cycle gas turbine, steam turbine and generator, and the first type of sensors are a resistance temperature device and a power measurement station and said topology further comprises the power meter generating data and communicating via general purpose interface bus (GPIB) format and a GPIB/Ethernet converter serving as an addressable node on the LAN, wherein the power meter is coupled to the GPIB bus. Further, the wireless mesh network may include RTD node radios that are each connected to one or more of the first type of sensors to transmit sensor data and said RTD radios transmit the data to a mesh node that will retransmit data received from RTD nodes or other of the mesh radios to a wireless bridge gateway connected to a data collection computer. The data collection computer will be connected to a router which will be connected to a wireless bridge. The wireless bridge will comprise a first bridge node (root node) connected to the LAN/intranet/internet located in a separate building which will transmit to a repeater/access point node transmitting to a second repeater/access point/non-root remote node connected to the router. In addition, the data transceiving radios may be serial data radios that retransmit serial data received from other serial data radios, and at least one of the serial data radios converts the serial data generated by the digital instruments to packetized data suitable for the LAN and connected to the router.

In another embodiment, the data communications topology for a facility comprises: a wireless mesh network of a first type of sensors monitoring the facility; a wireless data communication device linking the mesh network to a local area network (LAN) of computers, wherein the device is a node on the LAN, and a plurality of serial data radios each coupled to a digital instrument collecting data from at least a second type of sensors monitoring the facility, wherein the serial data radios are repeaters and include at least one of said radios serving as a node on the LAN.

Further, a method has been developed for communicating data over a facility having various incompatible data sources, said method comprising: establishing an local area network (LAN) for computer communications and control functions at the facility; collecting data from a first type of sensors monitoring a condition of the facility, wherein the collected data is transmitted to a wireless sensor mesh network; establishing a wireless bridge between the mesh network and the LAN, wherein the wireless bridge is an addressable noted on the LAN and communicates the collected data from the first type of sensors to the LAN; collecting data from a second type of sensors monitoring a second condition at the facility, wherein the second type of sensors communicate the collected data to a respective one of a plurality of serial data radios that transmit the data to other serial data radios; repeating the received transmissions of from the other serial data radios by the serial data radios; communicating the collected data from the second type of sensors by establishing one of the serial data radios as an addressable node on the LAN, and storing in a computer database on the LAN the collected data from the second type of sensors and the collected data from the first type of sensors.

### BRIEF DESCRIPTION OF THE DRAWING

FIG. 1 is an exemplary topology of a data collection system for a facility.

### DETAILED DESCRIPTION OF THE INVENTION

A data transmission topology has been developed for collecting and transmitting data from various sensors and other data sources in a facility and from/to locations remote of the facility. The topology includes serial data modems, serial to Ethernet converters, Ethernet to General Purpose Interface Bus (GPIB) converters, Serial to General Purpose Interface Bus (GPIB) converters, wireless data transmitters and wireless Ethernet radios, e.g., wireless bridges. These data transmission devices are used to transmit data collected from sensors, test instruments and other data generators that monitor a facility. The transmitted data is uploaded to data collection computer systems that may be networked using a LAN, intranet and/or internet.

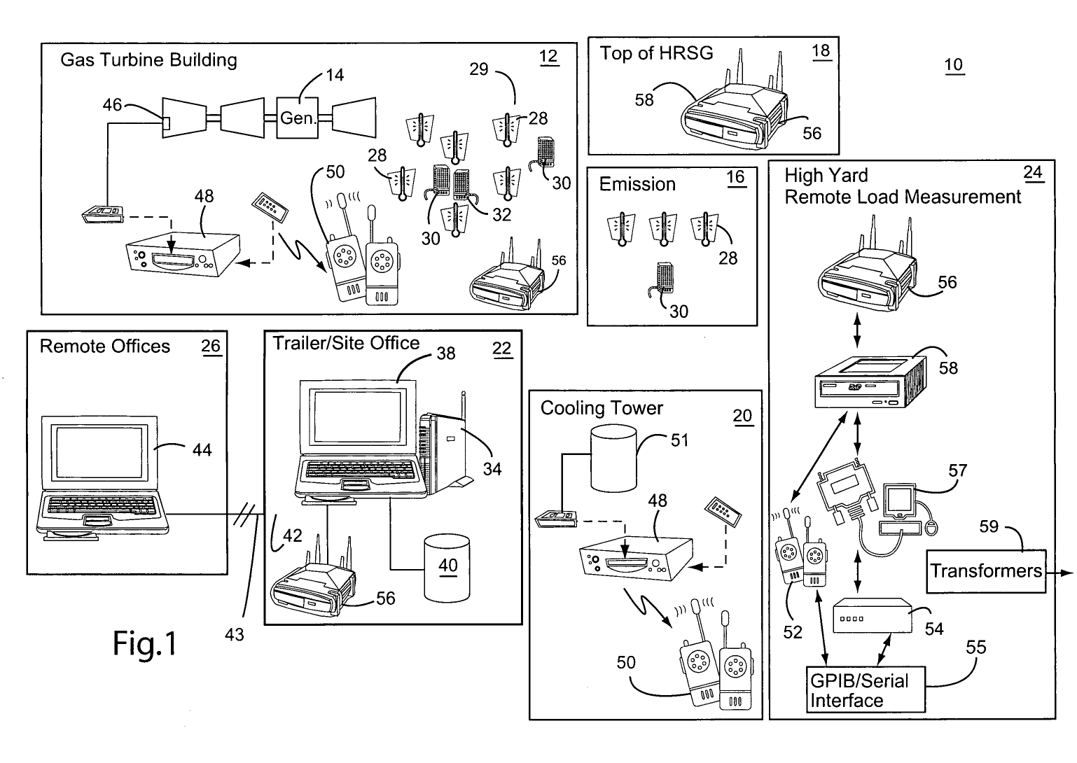

FIG. 1 is a schematic diagram of an exemplary data collection topology 10 for a large area power generation facility that comprises buildings 12 housing gas turbines, steam turbines and electrical power generators 14; an emission station 16 for the exhaust gases from the gas turbines; heat recovery steam generators (HRSG) 18; a cooling tower 20 for the steam turbines; a site office 22 (typically a trailer at the power generation facility), and a high yard 24 for power transmission equipment, maintenance equipment and spare parts to service the power generation devices and other equipment at the facility. The facility may cover tens or hundreds of acres, and include several buildings, roads, railroad tracks, power transmission facilities, and other infrastructure common to large facilities. In addition, individuals at remote offices 26 or operating from portable computers access the data generated by the power generation facility to monitor the operation of the facility.

The gas turbines, steam turbines and generators are monitored by an array of sensors 28. The sensors detect various conditions, such as temperature, fuel flow, rotational speed, humidity, pressure and ignition. The sensors may be powered, e.g., batteries, and wired to a transmitter. Each sensor may have an associated transmitter or several sensors may share a common transmitter. For example, a resistance-temperature device (RTD) node sold by Sensicast Systems of Needham, Mass., USA, is a wireless transmitter of digital temperature data collected from one or a group of resistance temperature sensors. In the embodiment disclosed herein, each temperature sensor has an associated RTD node that collects data from the sensor. The data may be transmitted serially in a data stream or as a series of data packets suitable for a packet switched network.

The RTD nodes may be linked together by mesh repeater radio 30, such as sold by Sensicast Systems, to form a mesh network 29 of temperature sensors. The mesh repeater radios receive wireless data transmissions from the RTD nodes 28. The mesh repeater radios 30 perform a repeater function by retransmitting the RTD node data for reception over a relatively wide area by other RTD nodes and other radios in the mesh network. Typically, the RTD nodes transmit a short distance, such as to a nearby mesh repeater radio, e.g., within 10 to 200 feet. The repeater radio 30 retransmits the data from the RTD units over a wider area, e.g., 30 to 700 feet. The retransmission ensures that the RTD sensor data is transmitted over the entire area of the mesh network.

The RTD sensor radios 28 and mesh repeater radios 30 can communicate with a wireless mesh bridge/gateway node 32 at a central location within a building 12 housing the turbines and generators. The mesh radios 28, 30 & 32 may have omni directional antenna that receive/transmit data in all directions at a relatively uniform signal strength. The wireless mesh bridge/gateway node 32 can be connected directly to the data collection computer 38 depending on the distance or to a wireless bridge/access point 56/router 58 that may transmit data over a relatively long wireless path, e.g., 700 feet to many miles. The wireless bridge node may transmit in a localized direction and communicate with another wireless bridge node 34 in a different building 12 across the facility. The wireless bridge nodes 34, 56 provide a data communication path between the mesh network 29 of temperature sensors 28 and a central computer system 38 for the facility.

The central computer system 38 may convert the data from the temperature sensors into a format suitable for storage in a database 40 associated with the computer system 38 or for transmission on a local area network (LAN) 42, e.g., an Ethernet network, operating within the facility. The LAN may be connected to other networks, such as via the Internet 43 or a wide-area-network (WAN). For example, the LAN may be accessible through the Internet by computers 44 at remote offices 26. From these remote computers 44, a user may monitor in real-time temperature data from sensors 28 monitoring tests being conducted on the gas turbine in the power generation system 14.

The wireless bridge nodes may be a Cisco Aironet® 1300 Wireless Bridges sold by Cisco Systems of San Jose, Calif. USA. The wireless bridge functions as a network node, e.g., of a local area network (LAN) 42, and handles communications in a standard network protocol, e.g., Ehternet or TCP/IP. The wireless bridge extends the LAN 42 so as to include the mesh network 29 of temperature sensors. The RTD nodes may transmit sensor data in packets that include routing information to send the temperature data to, for example, a central computer system 38 that stores the temperature data. Further, the RTD nodes may be remotely accessed using the LAN to monitor, adjust or update the temperature sensors.

The gas turbines and electrical power generators may also be instrumented with other sensors 46 that generate signals that are monitored by instruments 48 that generate digital data. Another example of sensors with digital instrumentations may include temperature sensors 51 in cooling towers at the facility. The data from the sensors 46, 51 and associated instruments 48 may be transmitted by serial data radios 50 across the facility to other serial data radios 50. A suitable serial data radio is a MaxStream RS-232/485 Radio sold by MaxStream, Inc. of Orem, Utah. The serial data radios may function as repeaters in that they retransmit data transmissions received by other same type serial data radios within the facility. The repeating serial data radios 50, 52 form a network for radio data transmissions that communicate sensor data over all or a predefined area of the facility.

Many of the serial data modems may not be directly connected to the LAN. At least one of the serial data modems 52 using a suitable serial data radio such as the MaxStream RS-232/485 to Ethernet Radio sold by MaxStream, Inc. of Orem, Utah, is connected as a node on the LAN. This Ethernet serial data modem 52 serves as a node on the LAN and converts the serial data transmitted by the serial radios 50 to a data format, e.g., Ethernet, suitable for the LAN. By using the serial data radio 50 as repeaters, each data modem can communicate with the serial radio 52 that is connected to the LAN and vice versa.

Devices and systems in the facility may include instruments that have digital communications that do conform to non-network data protocols. For example, power monitoring instruments 54 may communicate using the conventional General Purpose Interface Bus (GPIB) protocol, e.g., IEEE-488.2, that is commonly used for instrument communications. The power monitoring instruments may be at remote locations in the facility, such as in a high yard 24 where power transformers 59 and transmission lines are located. Power data from the power monitoring instruments are formatted in the GPIB protocol and transmitted via GPIB cable to a GPIB converter 57, e.g., an Agilent Ethernet GPIB controller sold by Agilent Technologies, Inc. of Palo Alto, Calif. The GPIB converter converts the GPIB data from the power meter 54 to an Ethernet protocol data suitable for the LAN. The GPIB converter 57 provides a means for transferring data from sensors that may conform the GPIB data format to the data protocols suitable for Ethernet.

The LAN network may include wireless links provided by wireless access points 56. These access points may operate in accordance with standardized protocols, e.g., IEEE 802.11 (“Wifi”), and provide wireless communications between the LAN and portable computers and other network compatible devices. The wireless access points 56 transmit data packets that will be conveyed through the LAN. The transmissions from one access point which sends the packets to LAN nodes connected to other wireless access points. The connections to the wireless access points may be wired or wireless. In this way, the wireless access points form links in the LAN.

Further, routers 58 in the LAN direct data packets to or from devices connected to the LAN, such as the Ethernet serial data modem radios 52, wireless access point 56 and converter 57. The router may be physically incorporated in the wireless access point.

Devices and systems in the facility may include instruments that have digital communications that do conform to non-network data protocols. For example, power monitoring instruments 54 may communicate using the conventional General Purpose Interface Bus (GPIB) protocol, e.g., IEEE-488.2, that is commonly used for instrument communications. The power monitoring instruments may be at remote locations in the facility, such as in a high yard 24 where power transformers 59 and transmission lines are located. Power data from the power monitoring instruments are formatted in the GPIB protocol and transmitted via wired to a GPIB/Serial Interface 55, e.g., an ICS GPIB/Serial Interface sold by ICS Electronics, Inc. of Pleasanton, Calif. The GPIB/Serial Interface converts the GPIB data from the power meter 54 to a serial protocol data and transmitted wirelessly using Ethernet serial data modem radios 52 to the central computer system 38 that stores the data. The GPIB/Serial Interface 55 provides a means for transferring data from instruments that may conform to the GPIB data format to the data protocols suitable for Serial communication.

The data topology 10, as disclosed here, includes a LAN 42, mesh network 29 and an array of serial radios 50, 52, each of which is an effective network. These networks may overlap in their coverage area in the facility. They are also interconnected through the LAN. The topology provides a means for multiple networks to communicate with each other while operating together to cover the same facility.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A data communications topology for a facility comprising:
a wireless mesh network of a first type of sensor monitoring the facility;
a wireless data communication device linking the wireless mesh network to a local area network (LAN) of computers, wherein the device is a node on the LAN;
a plurality of serial data radios each coupled to a digital instrument collecting data from a second type of sensor monitoring the facility, wherein the serial data radios are repeating transceivers and at least one of the radios is a node on the LAN.

2. The data communications topology of claim 1 wherein the facility includes a combined cycle gas turbine and steam turbine, and the first type of sensors are a resistance temperature device.

3. The data communication topology of claim 2 wherein the facility further comprises a power transmission station and said topology further comprises a power meter generating data general purpose interface bus (GPIB) format and a GPIB converter serving as an addressable node on the LAN, wherein the power meter is coupled to the GPIB bus.

4. The data communications topology of claim 1 wherein the wireless mesh network includes repeating mesh radios that are each connected to one or more of the first type of sensors to transmit sensor data and said mesh radios retransmit data received from other of the mesh radios.

5. The data communications topology of claim 1 wherein the wireless communication device includes a wireless bridge gateway wirelessly communicating data locally or between separate buildings.

6. The data communications topology of claim 1 wherein the serial data radios retransmit serial data received from other serial data radios, and at least one of the serial data radios converts the serial data generated by the digital instruments to packetized data suitable for the LAN.

7. The data communications topology of claim 1 wherein the mesh network is arranged in a first building of the facility and the plurality of repeating data transceiving radios are arranged in various buildings in the facility.

8. The data communications topology of claim 1 wherein the LAN includes wireless access devices that communicate with each other to form a wireless link in the LAN.

9. The data communications topology of claim 8 wherein the wireless access devices retransmit signals received from other wireless access devices.

10. A data communications topology for a facility comprising:
a wireless mesh network of a first type of sensors monitoring the facility;
a wireless data communication device linking the mesh network to a local area network (LAN) of computers, wherein the device is an addressable node on the LAN, and
a plurality of serial data radios each coupled to a digital instrument collecting data from at least a second type of sensors monitoring the facility, wherein the serial data radios are repeaters and include at least one of said radios serving as a node on the LAN.

11. The data communications topology of claim 10 wherein the wireless mesh network includes repeating mesh radios that are each connected to one or more of the first type of sensors to transmit sensor data and said mesh radios retransmit data received from other of the mesh radios.

12. The data communications topology of claim 11 wherein the wireless communication device includes a wireless mesh gateway/bridge connected to a first bridge node communicating with a second bridge node connected to the LAN, wherein the first and second bridge nodes are in separate buildings.

13. The data communications topology of claim 10 wherein the serial data radios retransmit serial data radios received from other serial data radios, and at least one of the serial data radios converts the serial data generated by the digital instruments to packtized data suitable for the LAN.

14. The data communications topology of claim 10 wherein the facility including a combined cycle gas turbine and steam turbine, and the first type of sensors is a resistance temperature device.

15. The data communication topology of claim 14 wherein the facility further comprises a power transmission station and said topology further comprises a power meter generating data general purpose interface bus (GPIB) format and a GPIB converter serving as an addressable node on the LAN, wherein the power meter is coupled to the GPIB bus.

16. A method for communicating data over a facility having various incompatible data sources, said method comprising:
establishing an local area network (LAN) for computer communications and monitoring functions at the facility;
collecting data from a first type of sensors monitoring a condition of the facility, wherein the collected data is transmitted to a wireless sensor mesh network;
establishing a wireless bridge between the mesh network and the LAN, wherein the wireless bridge is an addressable noted on the LAN and communicates the collected data from the first type of sensors to the LAN;
collecting data from a second type of sensors monitoring a second condition at the facility, wherein the second type of sensors communicate the collected data to a respective one of a plurality of serial data radios that transmit the data to other serial data radios;
repeating the received transmissions of from the other serial data radios by the serial data radios;
communicating the collected data from the second type of sensors by establishing one of the serial data radios as an addressable node on the LAN, and
storing in a computer database on the LAN the collected data from the second type of sensors and the collected data from the first type of sensors.

17. The method of claim 16 wherein the wireless mesh network includes repeating mesh radios that are each wireless connected to one or more of the first type of sensors to transmit sensor data and said mesh radios retransmit data received from other of the mesh radios.

18. The method of claim 16 wherein the serial data radios retransmit serial data received from other serial data receivers, and at least one of the serial data radios converts the serial data generated by the digital instruments to packtized data suitable for the LAN.

19. The method of claim 16 wherein the facility comprises a power transmission station and said topology further comprises a power meter generating data general purpose interface bus (GPIB) format and a GPIB converter serving as an addressable node on the LAN, wherein the power meter is coupled to the GPIB bus.

20. The method of claim 16 further comprising wireless access devices in the LAN that communicate with each other to form a wireless link in the LAN.
